(19) United States
(12) Patent Application Publication
(10) Pub. No.: US 2015/0298157 A1
(43) Pub. Date: Oct. 22, 2015

(54) SYSTEMS AND METHODS FOR DROPLET PRODUCTION AND MANIPULATION USING ACOUSTIC WAVES

(71) Applicants: President and Fellows of Harvard College, Cambridge, MA (US); UNIVERSITAT, Augsburg, Augsburg (DE)

(72) Inventors: David A. Weitz, Bolton, MA (US); Thomas Franke, Augsburg (DE); Lothar Schmid, Augsburg (DE)

(73) Assignee: President and Fellows of Harvard College, Cambridge, MA (US)

(21) Appl. No.: 14/438,753

(22) PCT Filed: Oct. 24, 2013
(86) PCT No.: PCT/US13/66591

§ 371 Date: Apr. 27, 2015

Related U.S. Application Data
(60) Provisional application No. 61/719,351, filed on Oct. 26, 2012.

(51) Int. Cl. B05B 17/06

(52) U.S. Cl. CPC B05B 17/0653

(57) ABSTRACT

Acoustic waves, including surface acoustic waves, are useful to control fluids. In one aspect, acoustic waves may be applied to a fluid flowing in a channel to control or alter its flow characteristics, e.g., its flow rate or direction. Acoustic waves are typically applied using electrically-controlled acoustic wave generators, and thus, the flow of fluid can be controlled to a surprisingly high degree. If the fluid is caused to form a series of droplets, then acoustic waves may be used to control the volume of fluid in each droplet, to alter the rate droplets are formed, or the like. Acoustic waves may be used to deflect the flow of fluid in a channel, and in some cases, to cause fluid to flow to different locations.

### RELATED APPLICATIONS

This application claims the benefit of U.S. Provisional Patent Application Ser. No. 61/719,351, filed Oct. 26, 2012, entitled “Systems and Methods for Droplet Production and Manipulation Using Acoustic Waves,” by Weitz, et al., incorporated herein by reference in its entirety.

### GOVERNMENT FUNDING

Research leading to various aspects of the present invention was sponsored, at least in part, by the NSF, Grant Nos. DMR-1006546 and DMR-0820484. The U.S. Government has certain rights in the invention.

### FIELD

The present invention generally relates to acoustic waves and surface acoustic waves.

### BACKGROUND

The manipulation of fluids to form fluid streams of desired configuration, discontinuous fluid streams, droplets, particles, dispersions, etc., for purposes of fluid delivery, product manufacture, analysis, and the like, is a relatively well-studied art. Examples of methods of producing droplets in a microfluidic system include the use of T-junctions or flow-focusing techniques. However, improvements in such techniques are still needed.

### SUMMARY

The present invention generally relates to acoustic waves and surface acoustic waves. The subject matter of the present invention involves, in some cases, interrelated products, alternative solutions to a particular problem, and/or a plurality of different uses of one or more systems and/or articles.

In one aspect, the present invention is generally directed to an article comprising a microfluidic substrate having defined therein a droplet-producing junction of at least a first microfluidic channel and a second microfluidic channel configured and arranged to create droplets of a first fluid contained by a second fluid, and an acoustic wave generator positioned to alter flow of fluid entering or leaving the droplet-producing junction.

In another aspect, the present invention is generally directed to an apparatus. The apparatus, in one set of embodiments, includes a first microfluidic channel and a second microfluidic channel intersecting at a junction, and an acoustic wave generator positioned upstream or downstream of the junction.

According to another set of embodiments, the apparatus comprises a first microfluidic channel, a second microfluidic channel ending at the first microfluidic channel to from a T junction, and an acoustic wave generator positioned to direct acoustic waves at at least a portion of the junction. In yet another set of embodiments, the apparatus includes a microfluidic channel having a bend, and an acoustic wave generator positioned to direct acoustic waves at at least a portion of the bend.

The present invention, in still another aspect, is directed to a method. In one set of embodiments, the method includes acts of flowing a first fluid through a first microfluidic channel and a second fluid through a second microfluidic channel such that, upon intersection of the first fluid and the second fluid at a junction, droplets of first fluid are formed contained by the second fluid, and applying an acoustic wave to the first fluid and/or the second fluid able to alter the rate of creation of the droplets and/or the volume of the droplets, relative to in the absence of the acoustic wave.

In another aspect, the present invention encompasses methods of making one or more of the embodiments described herein, for example, microfluidic devices comprising acoustic wave generators. In still another aspect, the present invention encompasses methods of using one or more of the embodiments described herein, for example, microfluidic devices comprising acoustic wave generators.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1C illustrate various systems and methods for controlling fluid flow in a channel using acoustic waves, in certain embodiments of the invention;

FIGS. 2A-2C illustrate various systems and methods for controlling droplet production using acoustic waves, in various embodiments of the invention;

FIGS. 3A-3B illustrate droplet formation controlled by acoustic waves, in certain embodiments of the invention;

FIGS. 4A-4B illustrate the control of droplet volumes using acoustic waves, in various embodiments of the invention;

FIGS. 5A-5C illustrate the control of fluid flow in a channel using surface acoustic waves, in some embodiments of the invention;

FIGS. 6A-6D illustrate various microfluidic devices having acoustic wave generators, in certain embodiments of the invention;

FIG. 7 illustrates an interdigitated transducer;

FIGS. 8A-8C illustrate the formation of droplets using an embodiment of the invention; and

FIGS. 9A-9D illustrate droplet formation in accordance with another embodiment of the invention.

### DETAILED DESCRIPTION

The present invention generally relates to acoustic waves, including surface acoustic waves, that are useful to control fluids. In one aspect, acoustic waves may be applied to a fluid flowing in a channel to control or alter its flow characteristics, e.g., its flow rate or direction. Acoustic waves are typically applied using electrically-controlled acoustic wave generators, and thus, the flow of fluid can be controlled to a surprisingly high degree. For example, if the fluid is caused to form a series of droplets, then acoustic waves may be used to control the volume of fluid in each droplet, to alter the rate droplets are formed, or the like. As another example, acoustic waves may be used to deflect the flow of fluid in a channel, and in some cases, to cause fluid to flow to different locations.

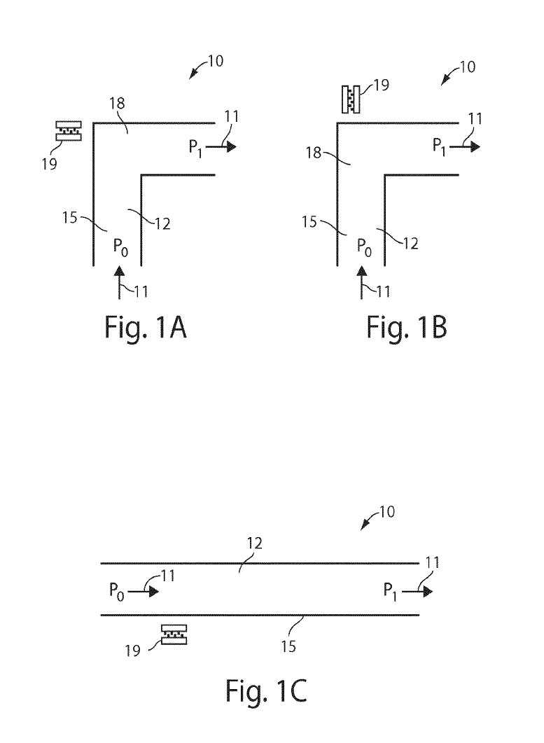

Turning first to FIG. 1A, one example of an embodiment of the invention where acoustic waves are used to control the flow of fluid in a channel, such as a microfluidic channel, is now described. In this figure, microfluidic system 10 includes microfluidic channel 15 having a bend 18. Although bend 18 is shown at a 90° angle, this is for illustrative purposes only; in other embodiments, bend 18 may be at an angle greater than 90° or less than 90°.

Flowing in microfluidic channel 15 is a fluid 12, flowing in the directions indicated by arrows 11. As shown here, the flow of fluid is caused by a pressure drop from an initial pressure P₀ to a final pressure P₁. One or more than one fluid may be present within microfluidic channel 15, although only one fluid is illustrated here for clarity. For example, in other embodiments, there may be a first fluid and a second fluid within microfluidic channel 15; for instance, the first fluid may be present as a series of droplets contained within the second fluid.

Also shown in FIG. 1A is acoustic wave generator 19, shown here as a interdigitated transducer. As will be discussed in detail below, however, in other embodiments, a variety of other devices may be used as an acoustic wave generator. In this figure, acoustic wave generator 19 is positioned such that it produces an acoustic wave directed towards bend 18 in the direction of fluid flow within microfluidic channel 15. Without wishing to be bound by any theory, by directing acoustic waves to the fluid, it is believed that acoustic wave generator 19 can alter the pressure of the fluid proximate the bend, e.g., decreasing the pressure as is shown in FIG. 1A. This may, for example, cause a decrease in the pressure difference between bend 18 and the final pressure P₁, and/or an increase in the flow rate of fluid through microfluidic channel 15.

A similar configuration is illustrated in FIG. 1B. As with FIG. 1A, microfluidic system 10 includes a microfluidic channel 15 having a bend 18, and fluid 12 flowing from an initial pressure P₀ to a final pressure P₁, as is indicated by arrows 11. However, the position of acoustic wave generator 19 is different. In this figure, unlike FIG. 1A, it is positioned proximate bend 18 such that it produces an acoustic wave in a direction opposite of fluid flow within microfluidic channel 15. In this configuration, it is believed that the application of acoustic waves on the fluid by acoustic wave generator 19 causes an increase in pressure, which may cause an increase in the pressure difference between bend 18 and the final pressure P₁, and/or a decrease in the flow rate of fluid through microfluidic channel 15.

It should be noted that these examples are by way of illustration only. Various embodiments of the present invention are generally directed to systems and methods of controlling fluid flow within channels, such as microfluidic channels, e.g., by applying acoustic waves to a portion of the fluid that are able to increase or decrease the pressure of the fluid at those portions, and/or that are able to significantly increase or decrease the flow rate of fluid through those portions. The acoustic waves may be directed at any portion of any channel containing a fluid, not necessarily at only a bend of a microfluidic channel. Such control of fluid flow may be used in various ways, e.g., as discussed herein. In addition, in some embodiments, more than one acoustic wave generator may be used to control fluid flow, e.g., which may act synergistically or even act in opposing ways, depending on the application.

In one aspect, the present invention is generally directed to applying acoustic waves, such as surface acoustic waves, to a fluid flowing in a channel, such as a microfluidic channel. A surface acoustic wave (“SAW”) is, generally speaking, an acoustic wave able to travel along the surface of a material exhibiting elasticity, with an amplitude that typically decays exponentially with depth into the material. By selecting suitable acoustic waves, pressure changes may be induced in the fluid, which can be used to manipulate the fluid in some cases. For example, acoustic waves applied to a fluid may increase or decrease the pressure on the fluid, which may cause the fluid to flow faster or slower due to the change in pressure, relative to fluid flow in the absence of the acoustic waves. As other examples, the acoustic waves may be used to deflect the fluid or to cause fluid to flow to a different location.

In some cases, the magnitude of the pressure change is related to the power or the amplitude of the applied acoustic waves. In certain embodiments, the acoustic waves may be applied at an amplitude and/or at a direction selected to alter a flow characteristic of the fluid, e.g., its flow rate or direction of flow. For instance, as is discussed in more detail below, in one set of embodiments, droplets of a first fluid may be formed within a second fluid, and the acoustic waves may be applied to alter the formation of the droplets, e.g., altering the rate of creation of droplets, the volume of the droplets, etc.

The acoustic waves may be applied at varying amplitudes or powers in some cases. In some cases, the pressure changes created in the fluid may be a function of the power of the acoustic wave. For example, the acoustic wave may have a power of at least about 0 dBm, at least about 3 dBm, at least about 6 dBm, at least about 9 dBm, at least about 12 dBm, at least about 15 dBm, at least about 20 dBM, etc. The surface acoustic wave may also have any suitable average frequency, in various embodiments. For example, the average frequency of the surface acoustic wave may be between about 100 MHz and about 200 MHz, between about 130 MHz and about 160 MHz, between about 140 MHz and about 150 MHz, between about 100 MHz and about 120 MHz, between about 120 MHz and about 140 MHz, between about 140 MHz and about 160 MHz, between about 160 MHz and about 180 MHz, or between about 180 MHz and about 200 MHz or the like, and/or combinations thereof. In other embodiments, the frequency may be between about 50 Hz and about 100 KHz, between about 100 Hz and about 2 kHz, between about 100 Hz and about 1,000 Hz, between about 1,000 Hz and about 10,000 Hz, between about 10,000 Hz and about 100,000 Hz, or the like, and/or combinations thereof. In some cases, the frequency may be at least about 10 Hz, at least about 30 Hz, at least about 50 Hz, at least about 100 Hz, at least about 300 Hz, at least about 1,000 Hz, at least about 3,000 Hz, at least about 10,000 Hz, at least about 30,000 Hz, at least about 100,000 Hz, at least about 300,000 Hz, at least about 1 MHz, at least about 3 MHz, at least about 10 MHz, at least about 30 MHz, at least about 100 MHz, at least about 300 MHz, or at least about 1 GHz or more in some embodiments. In certain instances, the frequency may be no more than about 1 GHz, no more than about 300 MHz, no more than about 100 MHz, no more than about 30 MHz, no more than about 10 MHz, no more than about 3 MHz, no more than about 1 MHz, no more than about 300,000 Hz, no more than about 100,000 Hz, no more than about 30,000 Hz, no more than about 10,000 Hz, no more than about 3,000 Hz, no more than about 1,000 Hz, no more than about 300 Hz, no more than about 100 Hz, or the like.

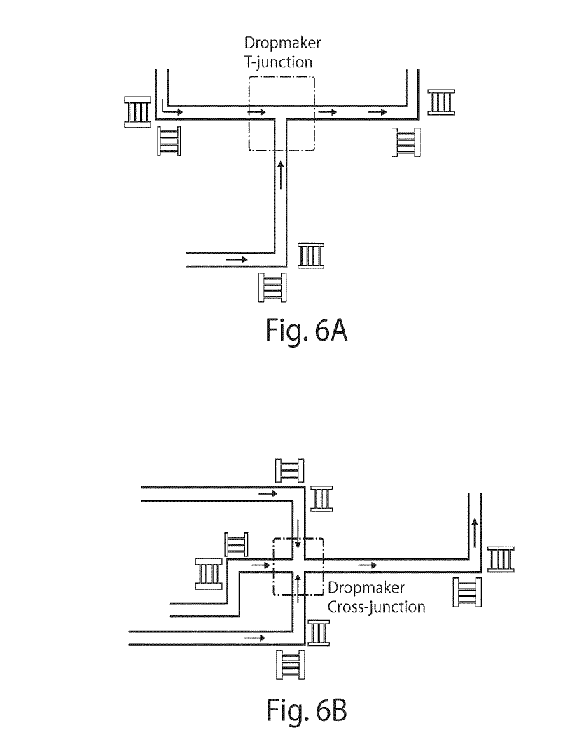

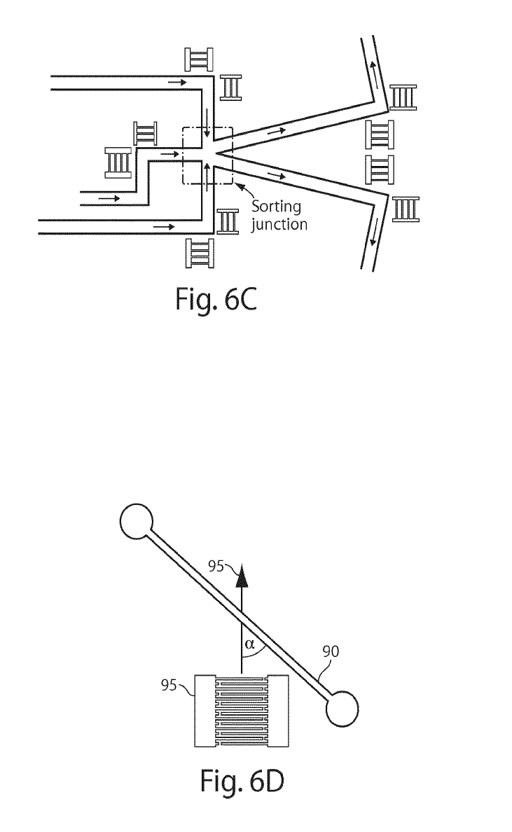

The acoustic waves may be applied, in some embodiments, in a downstream direction or an upstream direction, relative to the flow of fluid in a channel, which can be used to increase or decrease fluid flow within the channel. For example, acoustic waves may be applied to a channel, such as a microfluidic channel, in a direction of fluid flow within the channel, in a direction opposite of fluid flow within the channel, or in another direction (e.g., perpendicular to fluid flow within the channel). In other embodiments, the acoustic waves may be applied at any suitable angle relative to the microfluidic channel, for example, about 0°, about 5°, about 10°, about 20°, about 30°, about 40°, about 50°, about 60°, about 70°, about 80°, about 90°, about 100°, about 110°, about 120°, about 130°, about 140°, about 150°, about 160°, about 170°, about 175°, about 180° etc.). Thus, in FIG. 6D, the angle alpha between acoustic wave front 93 (produced by acoustic wave generator 95) and channel 90 may have any suitable value.

In some cases, more than one acoustic wave may be applied to control fluid flow within the channel. For example, a first acoustic wave generator may be used to increase the pressure within the channel and the second used to decrease the pressure within the channel (e.g., relative to the pressure when no acoustic waves are present), the first acoustic wave generator may be used to increase fluid flow and the second acoustic wave generator used to decrease fluid flow, etc. (e.g., relative to the fluid flow when no acoustic waves are present). The acoustic waves may be applied at the same, or different regions of a channel, depending on the application. For instance, in some cases, a first acoustic wave and a second acoustic wave may be applied to overlapping portions of a fluid, or a first acoustic wave may be applied to a first portion of a fluid within a channel, and the second acoustic wave may be applied to a second portion of the fluid within the channel. If more than one acoustic wave is applied to a fluid, the acoustic waves may be applied in any suitable order, e.g., simultaneously, sequentially, periodically, etc.

Without wishing to be bound by any theory, it should be noted that acoustic waves may be very rapidly controlled, e.g., electrically, and typically can be applied to fluids at very small time scales. Thus, individual regions of fluids, e.g., droplets of fluid as is discussed herein, may be controlled to an arbitrary degree, e.g., without affecting other regions or droplets of fluids, even nearby or adjacent ones. For example, an acoustic wave may be applied to a first region or droplet, then no acoustic wave may be applied, or an acoustic wave of a different magnitude and/or frequency, applied to an adjacent or nearby second region or droplet. Thus, each region or droplet can be independently controlled, without affecting adjacent or nearby regions or droplets. In contrast, in other microfluidic systems, such a high per-region or per-droplet basis for control of fluid or droplet characteristics cannot typically be achieved.

As non-limiting examples, in some cases, droplets having an arbitrary distribution of volumes may be created, e.g., a bimodal distribution of volumes, a trimodal distribution of volumes, etc. In some cases, the volume of the droplets may be controlled, e.g., such that the volume of the droplets is increased, or decreased, by at least about 5% more, relative to the volume of the droplets in the absence of the acoustic wave, and in some cases, such that the volume is increased or decreased by at least about 10%, at least about 15%, at least about 20%, at least about 25%, at least about 30%, at least about 35%, at least about 40%, at least about 45%, at least about 50%, etc., relative to the volume of the droplets in the absence of the acoustic wave. In another set of embodiments, the acoustic wave may be used to increase or decrease the rate of creation of droplets by at least about 5% more, and in some cases, by at least about 10%, at least about 15%, at least about 20%, at least about 25%, at least about 30%, at least about 35%, at least about 40%, at least about 45%, at least about 50%, etc., relative to the rate of creation in the absence of the acoustic wave. Other volume or rate changes are also possible.

In one set of embodiments, the characteristic response time, i.e., the time it takes to see a change in a fluid region or droplet created by the presence of the acoustic wave, may be smaller than the time it takes that fluid region or droplet to fully pass a specific location within the channel, thereby allowing a high degree of control of the fluid region or droplet. In contrast, many other systems or methods for controlling fluids within a channel, such as a microfluidic channel, typically rely on fluid characteristics or characteristics of the channel, which often have characteristic response times that are much longer, e.g., such that individual droplets or regions cannot be independently controlled.

In addition, in some cases, the acoustic waves may be applied continuously, or intermittently or “pulsed.” In some cases, the acoustic waves may be intermittently applied at a frequency, or in a way, such that individual droplets or regions are affected by the acoustic waves, but other droplets or regions are not. In addition, in some cases, the acoustic waves may be constant (i.e., having a fixed magnitude), or the acoustic wave may have an amplitude whose magnitude varies in time, e.g., the acoustic wave may have an amplitude that varies independently of the frequency of the acoustic wave.

As discussed, the acoustic waves may be applied to any suitable channel. In one set of embodiments, the acoustic waves are applied to a fluid contained within a channel, such as a microfluidic channel, to control the fluid. Various examples of microfluidic channels are discussed herein. More than one fluid may be present within the channel, in some instances, e.g., flowing as separate phases (for example, side-by-side, as droplets of a first fluid contained within a second fluid, etc.). As discussed herein, non-limiting examples of such channels include straight channels, bent channels, droplet-making channel configurations, and the like.

In some embodiments, the width of the channel may be chosen such that it is no more than about the full width at half maximum (FWHM) or 90% of the maximum of the acoustic wave or acoustic wave front. Without wishing to be bound by any theory, it is believed that such dimensions of the channel, relative to the acoustic wave or acoustic wave front, may decrease flow vortices that may be formed, which may decrease efficiency.

In one set of embodiments, acoustic waves may be applied at at least a portion of a bend of a channel. While FIGS. 1A and 1B shows acoustic waves applied to a 90° bend of a channel, this is by way of example only. In other embodiments, the bend may be of any suitable angle (e.g., about 5°, about 10°, about 20°, about 30°, about 40°, about 50°, about 60°, about 70°, about 80°, about 90°, about 100°, about 110°, about 120°, about 130°, about 140°, about 150°, about 160°, about 170°, about 175°, etc.), or there may be no bend present, e.g., as is shown in FIG. 1C. Also as discussed herein, more than one acoustic wave may be applied to the channel, e.g., at the same or different regions, using one or more acoustic wave generators as is discussed herein. In addition, in some embodiments, one acoustic wave generator can be applied to more than one channel simultaneously, e. g. by placing two or more channels side-by-side or by placing one or more channels at each end of the acoustic generator.

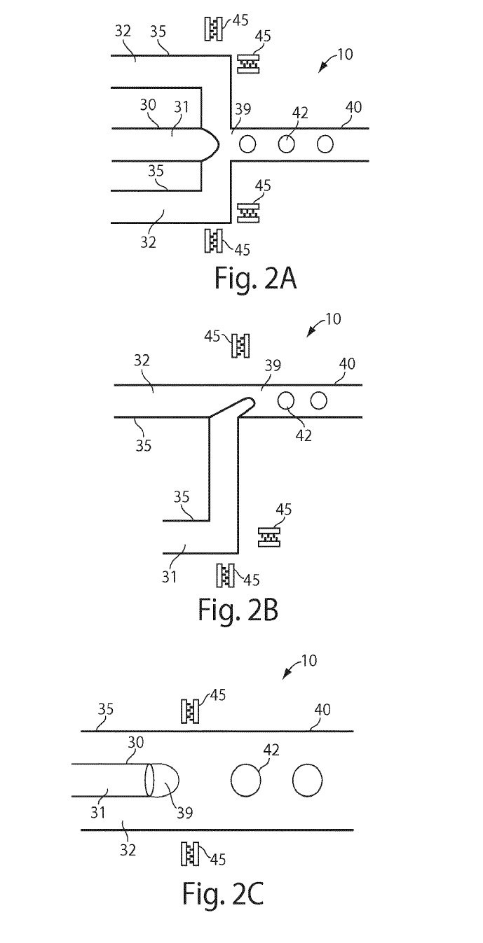

In another set of embodiments, acoustic waves may be applied to a microfluidic channels positioned in a droplet-making configuration at a droplet-producing junction. Examples of such configurations include, but are not limited, to flow-focusing junctions (FIG. 2A), T-junctions (FIG. 2B), and nested channel junctions (FIG. 2C). Still other examples are shown in FIG. 6. The droplet-producing junction may include various number of inlet channels and various number of outlet channels, e.g., as discussed herein.

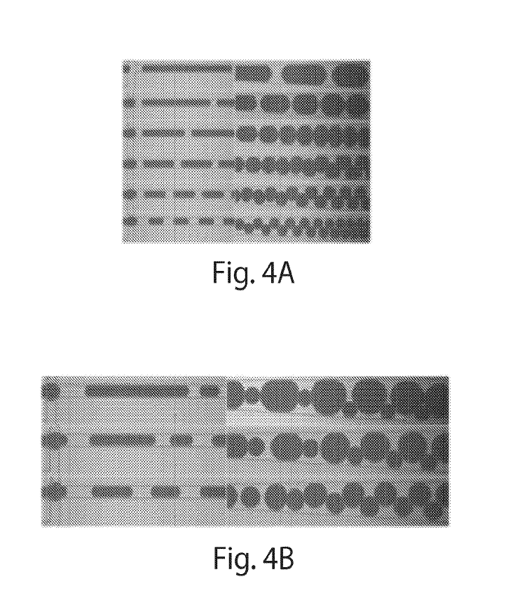

For example, in FIG. 2A, fluidic system 10 includes a first inlet channel 30, two second inlet channels 35, and an outlet channel 40. First channel 30 includes first fluid 31, while second channels 35 each include second fluid 32. At junction 39, droplets 42 of first fluid 31 contained within second fluid 32 are created. Also shown in FIG. 2A are various acoustic wave generators 45. Although 4 are shown in this figure, this is solely by way of example only. There may be more or fewer present, and/or they may be positioned at any suitable location within fluidic system 10, not necessarily at the positions indicated. As discussed herein, one or more of the acoustic wave generators 45 may be activated or controlled to create acoustic waves to control the formation of droplets 42. For example, the acoustic waves may be used to increase or decrease the relative flow rates of first fluid 31 or second fluid 32 within the inlet or outlet channels, which may be used to control the rate at which droplets 42 are formed, and/or control the amount of fluid contained within droplets 42. In some cases, the droplets may be individually or independently controlled, e.g., such that the droplets have differing sizes. See, e.g., FIG. 4.

As another example, a T-junction for creating droplets is shown in FIG. 2B. In this figure fluidic system 10 includes a first channel 30 and a second channel 35 intersecting at a droplet-producing junction 39, with fluid exiting through outlet channel 40. First channel 30 contains first fluid 31 while second channel 35 contains second fluid 32, which meet to form droplets 42 that exit along outlet channel 40. Also shown in FIG. 2B are various acoustic wave generators 45, which are positioned to control fluid flow within system 10. The positioning of these acoustic wave generators is by way of example only, and there may be more or fewer than these and/or they may be positioned in different locations, in other embodiments of the invention. As with FIG. 2A, these may be used to control the formation of droplets 42.

FIG. 2C shows another embodiment using nested channels to create droplets. In this example, first channel 30 is positioned within second channel 35, and first channel 30 contains first fluid 31 while second channel 35 contains second fluid 32. At junction 39, droplets 42 of first fluid 31 are formed within second fluid 32. Also shown in this figure are various acoustic wave generators 45, which are positioned to control fluid flow and the creation of droplets 42. As before, the positioning of these acoustic wave generators is by way of example only, and there may be more or fewer than these and/or they may be positioned in different locations.

Thus, in some embodiments, acoustic waves may be applied to droplets as they are being created, e.g., in various channels. In certain cases, this may occur even when the droplets themselves are created at relatively high rates of formation. For instance, at least about 10 droplets per second may be determined and/or sorted in some cases, and in other cases, at least about 20 droplets per second, at least about 30 droplets per second, at least about 100 droplets per second, at least about 200 droplets per second, at least about 300 droplets per second, at least about 500 droplets per second, at least about 750 droplets per second, at least about 1,000 droplets per second, at least about 1,500 droplets per second, at least about 2,000 droplets per second, at least about 3,000 droplets per second, at least about 5,000 droplets per second, at least about 7,500 droplets per second, at least about 10,000 droplets per second, at least about 15,000 droplets per second, at least about 20,000 droplets per second, at least about 30,000 droplets per second, at least about 50,000 droplets per second, at least about 75,000 droplets per second, at least about 100,000 droplets per second, at least about 150,000 droplets per second, at least about 200,000 droplets per second, at least about 300,000 droplets per second, at least about 500,000 droplets per second, at least about 750,000 droplets per second, at least about 1,000,000 droplets per second, at least about 1,500,000 droplets per second, at least about 2,000,000 or more droplets per second, or at least about 3,000,000 or more droplets per second may be created, and one or more acoustic waves applied to the droplets, e.g., control the volume of fluid in each droplet, and/or to alter the rate droplets are formed. In some cases, as discussed, this control may be on a single droplet basis, e.g., through the use of suitable acoustic waves.

In addition, in some embodiments using pulsed acoustic waves, the acoustic waves may be applied at similar modulation frequencies, i.e., at at least about 10 Hz, at least about 20 Hz, at least about 30 Hz, at least about 100 Hz, at least about 200 Hz, at least about 300 Hz, at least about 500 Hz, at least about 750 Hz, at least about 1,000 Hz, at least about 1,500 Hz, at least about 2,000 Hz, at least about 3,000 Hz, at least about 5,000 Hz, at least about 7,500 Hz, at least about 10,000 Hz, at least about 15,000 Hz, at least about 20,000 Hz, at least about 30,000 Hz, at least about 50,000 Hz, at least about 75,000 Hz, at least about 100,000 Hz, at least about 150,000 Hz, at least about 200,000 Hz, at least about 300,000 Hz, at least about 500,000 Hz, at least about 750,000 Hz, at least about 1,000,000 Hz, at least about 1,500,000 Hz, at least about 2,000,000 Hz, or at least about 3,000,000 Hz.

Thus, droplets may be created within the microfluidic channels using any suitable technique, and in various embodiments, many different droplet creation techniques may be used. Acoustic waves can be applied to the microfluidic channels to control droplet formation, e.g., to the intersection or junction where droplets are being formed, or to regions that are upstream or downstream from this. As mentioned, in some cases, the acoustic waves may be applied (or not applied) to single droplets, e.g., independently of other droplets, and in some embodiments, an acoustic wave may be applied to a droplet independently of the acoustic waves applied to other droplets.

Accordingly, the droplets may be substantially the same size, or may not necessarily be substantially the same size, depending on the embodiment. Other examples of droplet-forming junctions may be seen in, for example, U.S. patent application Ser. No. 11/246,911, filed Oct. 7, 2005, entitled “Formation and Control of Fluidic Species,” by Link, et al., published as U.S. Patent Application Publication No. 2006/0163385 on Jul. 27, 2006; U.S. patent application Ser. No. 11/024,228, filed Feb. 28, 2004, entitled “Method and Apparatus for Fluid Dispersion,” by Stone, et al., now U.S. Pat. No. 7,708,949, issued May 4, 2010; or U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007, each incorporated herein by reference in its entirety.

In addition, various aspects of the present invention relate to the control and manipulation of fluidic species, for example, in microfluidic systems. In one set of embodiments, droplets may be sorted using surface acoustic waves. The droplets may contain cells or other species. Examples of species include, but are not limited to, a chemical, biochemical, or biological entity, a cell, a particle, a bead, gases, molecules, a pharmaceutical agent, a drug, DNA, RNA, proteins, a fragrance, a reactive agent, a biocide, a fungicide, a pesticide, a preservative, or the like. Thus, the species can be any substance that can be contained in a fluid and can be differentiated from the fluid containing the species. For example, the species may be dissolved or suspended in the fluid. The species may be present in one or more of the fluids. If the fluids contain droplets, the species can be present in some or all of the droplets. Additional non-limiting examples of species that may be present include, for example, biochemical species such as nucleic acids such as siRNA, RNAi and DNA, proteins, peptides, or enzymes. Still other examples of species include, but are not limited to, nanoparticles, quantum dots, fragrances, proteins, indicators, dyes, fluorescent species, chemicals, or the like. As yet another example, the species may be a drug, pharmaceutical agent, or other species that has a physiological effect when ingested or otherwise introduced into the body, e.g., to treat a disease, relieve a symptom, or the like. In some embodiments, the drug may be a small-molecule drug, e.g., having a molecular weight of less than about 1000 Da or less than about 2000 Da.

In some cases, the surface acoustic waves may be created using a surface acoustic wave generator such as an interdigitated transducer, and/or a material such as a piezoelectric substrate. The piezoelectric substrate may be isolated from the substrate except at or proximate the location where the acoustic waves are to be applied, e.g., proximate a first or second channel, proximate a junction of two or more channels, etc. At such locations, the substrate may be coupled to the piezoelectric substrate (or other material) by one or more coupling regions.

In one aspect, the invention provides systems and methods for sorting fluidic droplets in a liquid, and in some cases, at relatively high rates. For example, a characteristic of a droplet may be sensed and/or determined in some fashion (e.g., as further described herein), then the droplet may be directed towards a particular region of the device, such as a microfluidic channel, for example, for sorting purposes.

In certain embodiments, the substrate contains at least an inlet channel, a first (outlet) channel, and a second (outlet) channel meeting at a junction, e.g., having a “Y” or a “T” shape. In some cases, more than one inlet channel and/or more than one outlet channel meeting at the junction may be present. By suitable application of surface acoustic waves, droplets contained within a fluid flowing through the inlet channel may be directed into the first channel or second channel. In other embodiments, however, other configurations of channels and junctions may be used, e.g., as described herein. Droplets contained within microfluidic channels are discussed in detail below.

Any suitable technique may be used to create a surface acoustic wave. For example, the surface acoustic wave may be created by a generator attached to the surface of a material. In certain embodiments, the surface acoustic wave is created by using an interdigitated electrode or transducer able to convert electrical signals into acoustic waves able to travel along the surface of a material, and in some cases, the frequency of the surface acoustic waves may be controlled by controlling the spacing of the finger repeat distance of the interdigitated electrode or transducer. The surface acoustic waves can be formed on a piezoelectric substrate or other material that may be coupled to a microfluidic substrate at specific locations, e.g., at locations within the microfluidic substrate where sorting is to take place. Suitable voltages (e.g., sinusoidal or other periodically varying voltages) are applied to the piezoelectric substrate, which converts the electrical signals into mechanical vibrations, i.e., surface acoustic waves or sound. The sound is then coupled to the microfluidic substrate, e.g., from the surface of the material. In the microfluidic substrate, the vibrations pass into liquid within microfluidic channels in the microfluidic substrate (e.g., liquid containing droplets containing cells or other species to be sorted), which give rise to internal streaming within the fluid. Thus, by controlling the applied voltage, streaming within the microfluidic channel may be controlled, which may be used to direct or sort droplets within the microfluidic channel, e.g., to particular regions within the microfluidic substrate.

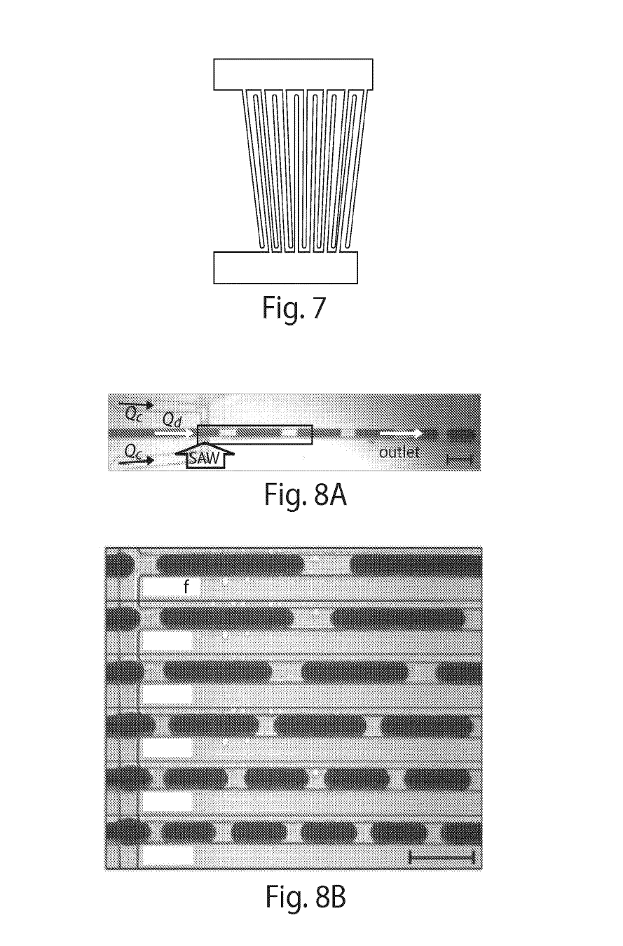

An interdigitated transducer typically comprises one, two, or more electrodes containing a plurality of “fingers” extending away from the electrode, wherein at least some of the fingers are interdigitated. The fingers may be of any length, and may independently have the same or different lengths. The fingers may be spaced on the transducer regularly or irregularly. In some cases, the fingers may be substantially parallel, although in other embodiments they need not be substantially parallel. For example, in one set of embodiments, the interdigitated transducer is a tapered interdigitated transducer. In some cases, the fingers in a tapered interdigitated transducer may be arranged such that the fingers are angled inwardly, e.g., as shown in FIG. 7. Examples of such transducers may be found, e.g., in International Patent Application No. PCT/US2011/048804, filed Aug. 23, 2011, entitled “Acoustic Waves in Microfluidics,” by Weitz, et al., published as WO 2012/027366 on Mar. 1, 2012; and U.S. Provisional Patent Application Ser. No. 61/665,087, filed Jun. 27, 2012, entitled “Control of Entities Such as Droplets and Cells Using Acoustic Waves,” by Weitz, et al., each incorporated herein by reference in their enteritis.

The interdigitated electrode typically includes of two interlocking comb-shaped metallic electrodes that do not touch, but are interdigitated. The electrodes may be formed from any suitable electrode material, for example, metals such as gold, silver, copper, nickel, or the like. The operating frequency of the interdigitated electrode may be determined, in some embodiments, by the ratio of the sound velocity in the substrate to twice the finger spacing. For instance, in one set of embodiments, the finger repeat distance may be between about 10 micrometers and about 40 micrometers, between about 10 micrometers and about 30 micrometers, between about 20 micrometers and about 40 micrometers, between about 20 micrometers and about 30 micrometers, or between about 23 micrometers and about 28 micrometers.

The interdigitated electrode may be positioned on a piezoelectric substrate, or other material able to transmit surface acoustic waves, e.g., to a coupling region. The piezoelectric substrate may be formed out of any suitable piezoelectric material, for example, quartz, lithium niobate, lithium tantalate, lanthanum gallium silicate, etc. In one set of embodiments, the piezoelectric substrate is anisotropic, and in some embodiments, the piezoelectric substrate is a Y-cut LiNbO₃ material.

The piezoelectric substrate may be activated by any suitable electronic input signal or voltage to the piezoelectric substrate (or portion thereof). For example, the input signal may be one in which a periodically varying signal is used, e.g., to create corresponding acoustic waves. For instance, the signals may be sine waves, square waves, sawtooth waves, triangular waves, or the like. The frequency may be for example, between about 50 Hz and about 100 KHz, between about 100 Hz and about 2 kHz, between about 100 Hz and about 1,000 Hz, between about 1,000 Hz and about 10,000 Hz, between about 10,000 Hz and about 100,000 Hz, or the like, and/or combinations thereof. In some cases, the frequency may be at least about 50 Hz, at least about 100 Hz, at least about 300 Hz, at least about 1,000 Hz, at least about 3,000 Hz, at least about 10,000 Hz, at least about 30,000 Hz, at least about 100,000 Hz, at least about 300,000 Hz, at least about 1 MHz, at least about 3 MHz, at least about 10 MHz, at least about 30 MHz, at least about 100 MHz, at least about 300 MHz, or at least about 1 GHz or more in some embodiments. In certain instances, the frequency may be no more than about 1 GHz, no more than about 300 MHz, no more than about 100 MHz, no more than about 30 MHz, no more than about 10 MHz, no more than about 3 MHz, no more than about 1 MHz, no more than about 300,000 Hz, no more than about 100,000 Hz, no more than about 30,000 Hz, no more than about 10,000 Hz, no more than about 3,000 Hz, no more than about 1,000 Hz, no more than about 300 Hz, no more than about 100 Hz, or the like.

The interdigitated electrode may be positioned on the piezoelectric substrate (or other suitable material) such that acoustic waves produced by the interdigitated electrodes are directed at a region of acoustic coupling between the piezoelectric substrate and the microfluidic substrate. For example, the piezoelectric substrate and the microfluidic substrate may be coupled or physically bonded to each other, for example, using ozone plasma treatment, or other suitable techniques. In some cases, the rest of the piezoelectric substrate and the microfluidic substrate are at least acoustically isolated from each other, and in certain embodiments, the piezoelectric substrate and the microfluidic substrate are physically isolated from each other. Without wishing to be bound by any theory, it is believed that due to the isolation, acoustic waves created by the interdigitated electrode and the piezoelectric substrate do not affect the microfluidic substrate except at regions where it is desired that the acoustic waves are applied, e.g., at a channel or a junction.

The coupling region may have any suitable shape and/or size. The coupling region may be round, oval, or have other shapes, depending on the embodiment. In some cases, two, three, or more coupling regions may be used. In one set of embodiments, the coupling region is sized to be contained within a microfluidic channel. In other embodiments, however, the coupling region may be larger. The coupling region may be positioned within a channel or proximate to the channel, in some embodiments.

In some cases, control of the droplets into one of the channels may be achieved by using a tapered interdigitated transducer. A tapered interdigitated transducer may allow relatively high control of the location at which a SAW is applied to a channel, in contrast to an interdigitated transducer where all of the fingers are parallel to each other and the spacing between electrodes is constant. Without wishing to be bound by any theory, it is believed that the location which a SAW can be applied by an interdigitated transducer is controlled, at least in part, by the spacing between the electrodes. By controlling the potential applied to the interdigitated transducer, and thereby controlling the resonance frequency of the applied SAW, the position and/or the strength of the SAW as applied by the interdigitated transducer may be correspondingly controlled. Thus, for example, applying a first voltage to an interdigitated transducer may cause a first resonance frequency of the resulting SAW to be applied (e.g., within a channel), while applying a second voltage may cause a second resonance frequency of the resulting SAW to be applied to a different location (e.g., within the channel). As another example, a plurality of coupling regions may be used, e.g., in combination with one or more tapered interdigitated transducers.

The microfluidic substrate may be any suitable substrate which contains or defines one or more microfluidic channels. For instance, as is discussed below, the microfluidic substrate may be formed out of polydimethylsiloxane, polytetrafluoroethylene, or other suitable elastomeric polymers, at least according to various non-limiting examples.

Other examples of the production of droplets of fluid surrounded by a liquid are described in International Patent Application Serial No. PCT/US2004/010903, filed Apr. 9, 2004 by Link, et al. and International Patent Application Serial No. PCT/US03/20542, filed Jun. 30, 2003 by Stone, et al., published as WO 2004/002627 on Jan. 8, 2004, each incorporated herein by reference. In various embodiments, acoustic waves may be applied to such systems.

A variety of definitions are now provided which will aid in understanding various aspects of the invention. Following, and interspersed with these definitions, is further disclosure that will more fully describe the invention. As noted, various aspects of the present invention relate to droplets of fluid surrounded by a liquid (e.g., suspended). The droplets may be of substantially the same shape and/or size, or of different shapes and/or sizes, depending on the particular application. As used herein, the term “fluid” generally refers to a substance that tends to flow and to conform to the outline of its container, i.e., a liquid, a gas, a viscoelastic fluid, etc. Typically, fluids are materials that are unable to withstand a static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids. The fluids may each be miscible or immiscible. For example, two fluids can be selected to be essentially immiscible within the time frame of formation of a stream of fluids, or within the time frame of reaction or interaction. Where the portions remain liquid for a significant period of time, then the fluids should be essentially immiscible. Where, after contact and/or formation, the dispersed portions are quickly hardened by polymerization or the like, the fluids need not be as immiscible. Those of ordinary skill in the art can select suitable miscible or immiscible fluids, using contact angle measurements or the like, to carry out the techniques of the invention.

As used herein, a first entity is “surrounded” by a second entity if a closed planar loop can be drawn around the first entity through only the second entity. A first entity is “completely surrounded” if closed loops going through only the second entity can be drawn around the first entity regardless of direction (orientation of the loop). In one embodiment, the first entity is a cell, for example, a cell suspended in media is surrounded by the media. In another embodiment, the first entity is a particle. In yet another embodiment, the first entity is a fluid. The second entity may also be a fluid in some cases (e.g., as in a suspension, an emulsion, etc.), for example, a hydrophilic liquid may be suspended in a hydrophobic liquid, a hydrophobic liquid may be suspended in a hydrophilic liquid, a gas bubble may be suspended in a liquid, etc. Typically, a hydrophobic liquid and a hydrophilic liquid are essentially immiscible with respect to each other, where the hydrophilic liquid has a greater affinity to water than does the hydrophobic liquid. Examples of hydrophilic liquids include, but are not limited to, water and other aqueous solutions comprising water, such as cell or biological media, salt solutions, etc., as well as other hydrophilic liquids such as ethanol. Examples of hydrophobic liquids include, but are not limited to, oils such as hydrocarbons, silicone oils, mineral oils, fluorocarbon oils, organic solvents etc. Other examples of suitable fluids have been previously described.

Similarly, a “droplet,” as used herein, is an isolated portion of a first fluid that is completely surrounded by a second fluid. It is to be noted that a droplet is not necessarily spherical, but may assume other shapes as well, for example, depending on the external environment. In one embodiment, the droplet has a minimum cross-sectional dimension that is substantially equal to the largest dimension of the channel perpendicular to fluid flow in which the droplet is located.

As mentioned, in some, but not all embodiments, the systems and methods described herein may include one or more microfluidic components, for example, one or more microfluidic channels. “Microfluidic,” as used herein, refers to a device, apparatus or system including at least one fluid channel having a cross-sectional dimension of less than 1 mm, and a ratio of length to largest cross-sectional dimension of at least 3:1. A “microfluidic channel,” as used herein, is a channel meeting these criteria. The “cross-sectional dimension” of the channel is measured perpendicular to the direction of fluid flow within the channel. Thus, some or all of the fluid channels in microfluidic embodiments of the invention may have maximum cross-sectional dimensions less than 2 mm, and in certain cases, less than 1 mm. In one set of embodiments, all fluid channels containing embodiments of the invention are microfluidic or have a largest cross sectional dimension of no more than 2 mm or 1 mm. In certain embodiments, the fluid channels may be formed in part by a single component (e.g. an etched substrate or molded unit). Of course, larger channels, tubes, chambers, reservoirs, etc. can be used to store fluids and/or deliver fluids to various components or systems of the invention. In one set of embodiments, the maximum cross-sectional dimension of the channel(s) containing embodiments of the invention is less than 500 microns, less than 200 microns, less than 100 microns, less than 50 microns, or less than 25 microns.

A “channel,” as used herein, means a feature on or in an article (substrate) that at least partially directs flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and/or outlet(s). A channel may also have an aspect ratio (length to average cross sectional dimension) of at least 2:1, more typically at least 3:1, 5:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus).

The channel may be of any size, for example, having a largest dimension perpendicular to fluid flow of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flowrate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, positioned to intersect with each other, etc.

In one set of embodiments, the fluidic droplets may contain cells or other entities, such as proteins, viruses, macromolecules, particles, etc. As used herein, a “cell” is given its ordinary meaning as used in biology. The cell may be any cell or cell type. For example, the cell may be a bacterium or other single-cell organism, a plant cell, or an animal cell. If the cell is a single-cell organism, then the cell may be, for example, a protozoan, a trypanosome, an amoeba, a yeast cell, algae, etc. If the cell is an animal cell, the cell may be, for example, an invertebrate cell (e.g., a cell from a fruit fly), a fish cell (e.g., a zebrafish cell), an amphibian cell (e.g., a frog cell), a reptile cell, a bird cell, or a mammalian cell such as a primate cell, a bovine cell, a horse cell, a porcine cell, a goat cell, a dog cell, a cat cell, or a cell from a rodent such as a rat or a mouse. If the cell is from a multicellular organism, the cell may be from any part of the organism. For instance, if the cell is from an animal, the cell may be a cardiac cell, a fibroblast, a keratinocyte, a heptaocyte, a chondracyte, a neural cell, a osteocyte, a muscle cell, a blood cell, an endothelial cell, an immune cell (e.g., a T-cell, a B-cell, a macrophage, a neutrophil, a basophil, a mast cell, an eosinophil), a stem cell, etc. In some cases, the cell may be a genetically engineered cell. In certain embodiments, the cell may be a Chinese hamster ovarian (“CHO”) cell or a 3T3 cell.

A variety of materials and methods, according to certain aspects of the invention, can be used to form any of the above-described components of the systems and devices of the invention. In some cases, the various materials selected lend themselves to various methods. For example, various components of the invention can be formed from solid materials, in which the channels can be formed via micromachining, film deposition processes such as spin coating and chemical vapor deposition, laser fabrication, photolithographic techniques, etching methods including wet chemical or plasma processes, and the like. See, for example, Scientific American, 248:44-55, 1983 (Angell, et al). In one embodiment, at least a portion of the fluidic system is formed of silicon by etching features in a silicon chip. Technologies for precise and efficient fabrication of various fluidic systems and devices of the invention from silicon are known. In another embodiment, various components of the systems and devices of the invention can be formed of a polymer, for example, an elastomeric polymer such as polydimethylsiloxane (“PDMS”), polytetrafluoroethylene (“PTFE” or Teflon®), or the like.

Different components can be fabricated of different materials. For example, a base portion including a bottom wall and side walls can be fabricated from an opaque material such as silicon or PDMS, and a top portion can be fabricated from a transparent or at least partially transparent material, such as glass or a transparent polymer, for observation and/or control of the fluidic process. Components can be coated so as to expose a desired chemical functionality to fluids that contact interior channel walls, where the base supporting material does not have a precise, desired functionality. For example, components can be fabricated as illustrated, with interior channel walls coated with another material. Material used to fabricate various components of the systems and devices of the invention, e.g., materials used to coat interior walls of fluid channels, may desirably be selected from among those materials that will not adversely affect or be affected by fluid flowing through the fluidic system, e.g., material(s) that is chemically inert in the presence of fluids to be used within the device.

In one embodiment, various components of the invention are fabricated from polymeric and/or flexible and/or elastomeric materials, and can be conveniently formed of a hardenable fluid, facilitating fabrication via molding (e.g. replica molding, injection molding, cast molding, etc.). The hardenable fluid can be essentially any fluid that can be induced to solidify, or that spontaneously solidifies, into a solid capable of containing and/or transporting fluids contemplated for use in and with the fluidic network. In one embodiment, the hardenable fluid comprises a polymeric liquid or a liquid polymeric precursor (i.e. a “prepolymer”). Suitable polymeric liquids can include, for example, thermoplastic polymers, thermoset polymers, or mixture of such polymers heated above their melting point. As another example, a suitable polymeric liquid may include a solution of one or more polymers in a suitable solvent, which solution forms a solid polymeric material upon removal of the solvent, for example, by evaporation. Such polymeric materials, which can be solidified from, for example, a melt state or by solvent evaporation, are well known to those of ordinary skill in the art. A variety of polymeric materials, many of which are elastomeric, are suitable, and are also suitable for forming molds or mold masters, for embodiments where one or both of the mold masters is composed of an elastomeric material. A non-limiting list of examples of such polymers includes polymers of the general classes of silicone polymers, epoxy polymers, and acrylate polymers. Epoxy polymers are characterized by the presence of a three-membered cyclic ether group commonly referred to as an epoxy group, 1,2-epoxide, or oxirane. For example, diglycidyl ethers of bisphenol A can be used, in addition to compounds based on aromatic amine, triazine, and cycloaliphatic backbones. Another example includes the well-known Novolac polymers. Non-limiting examples of silicone elastomers suitable for use according to the invention include those formed from precursors including the chlorosilanes such as methylchlorosilanes, ethylchlorosilanes, phenylchlorosilanes, etc.

Silicone polymers are preferred in one set of embodiments, for example, the silicone elastomer polydimethylsiloxane. Non-limiting examples of PDMS polymers include those sold under the trademark Sylgard by Dow Chemical Co., Midland, Mich., and particularly Sylgard 182, Sylgard 184, and Sylgard 186. Silicone polymers including PDMS have several beneficial properties simplifying fabrication of the microfluidic structures of the invention. For instance, such materials are inexpensive, readily available, and can be solidified from a prepolymeric liquid via curing with heat. For example, PDMSs are typically curable by exposure of the prepolymeric liquid to temperatures of about, for example, about 65° C. to about 75° C. for exposure times of, for example, about an hour. Also, silicone polymers, such as PDMS, can be elastomeric and thus may be useful for forming very small features with relatively high aspect ratios, necessary in certain embodiments of the invention. Flexible (e.g., elastomeric) molds or masters can be advantageous in this regard.

One advantage of forming structures such as microfluidic structures of the invention from silicone polymers, such as PDMS, is the ability of such polymers to be oxidized, for example by exposure to an oxygen-containing plasma such as an air plasma, so that the oxidized structures contain, at their surface, chemical groups capable of cross-linking to other oxidized silicone polymer surfaces or to the oxidized surfaces of a variety of other polymeric and non-polymeric materials. Thus, components can be fabricated and then oxidized and essentially irreversibly sealed to other silicone polymer surfaces, or to the surfaces of other substrates reactive with the oxidized silicone polymer surfaces, without the need for separate adhesives or other sealing means. In most cases, sealing can be completed simply by contacting an oxidized silicone surface to another surface without the need to apply auxiliary pressure to form the seal. That is, the pre-oxidized silicone surface acts as a contact adhesive against suitable mating surfaces. Specifically, in addition to being irreversibly sealable to itself, oxidized silicone such as oxidized PDMS can also be sealed irreversibly to a range of oxidized materials other than itself including, for example, glass, silicon, silicon oxide, quartz, silicon nitride, polyethylene, polystyrene, glassy carbon, and epoxy polymers, which have been oxidized in a similar fashion to the PDMS surface (for example, via exposure to an oxygen-containing plasma). Oxidation and sealing methods useful in the context of the present invention, as well as overall molding techniques, are described in the art, for example, in an article entitled “Rapid Prototyping of Microfluidic Systems and Polydimethylsiloxane,” Anal. Chem., 70:474-480, 1998 (Duffy et al.), incorporated herein by reference.

Another advantage to forming microfluidic structures of the invention (or interior, fluid-contacting surfaces) from oxidized silicone polymers is that these surfaces can be much more hydrophilic than the surfaces of typical elastomeric polymers (where a hydrophilic interior surface is desired). Such hydrophilic channel surfaces can thus be more easily filled and wetted with aqueous solutions than can structures comprised of typical, unoxidized elastomeric polymers or other hydrophobic materials.

In one embodiment, a bottom wall is formed of a material different from one or more side walls or a top wall, or other components. For example, the interior surface of a bottom wall can comprise the surface of a silicon wafer or microchip, or other substrate. Other components can, as described above, be sealed to such alternative substrates. Where it is desired to seal a component comprising a silicone polymer (e.g. PDMS) to a substrate (bottom wall) of different material, the substrate may be selected from the group of materials to which oxidized silicone polymer is able to irreversibly seal (e.g., glass, silicon, silicon oxide, quartz, silicon nitride, polyethylene, polystyrene, epoxy polymers, and glassy carbon surfaces which have been oxidized). Alternatively, other sealing techniques can be used, as would be apparent to those of ordinary skill in the art, including, but not limited to, the use of separate adhesives, thermal bonding, solvent bonding, ultrasonic welding, etc.

The following documents are incorporated herein by reference in their entireties: International Patent Application No. PCT/US2011/048804, filed Aug. 23, 2011, entitled “Acoustic Waves in Microfluidics,” by Weitz, et al., published as WO 2012/027366 on Mar. 1, 2012; and U.S. Provisional Patent Application Ser. No. 61/665,087, filed Jun. 27, 2012, entitled “Control of Entities Such as Droplets and Cells Using Acoustic Waves,” by Weitz, et al.

In addition, the following documents are incorporated herein by reference: U.S. patent application Ser. No. 11/360,845, filed Feb. 23, 2006, entitled “Electronic Control of Fluidic Species,” by Link, et al., published as U.S. Patent Application Publication No. 2007/0003442 on Jan. 4, 2007; U.S. patent application Ser. No. 08/131,841, filed Oct. 4, 1993, entitled “Formation of Microstamped Patterns on Surfaces and Derivative Articles,” by Kumar, et al., now U.S. Pat. No. 5,512,131, issued Apr. 30, 1996; priority to International Patent Application No. PCT/US96/03073, filed Mar. 1, 1996, entitled “Microcontact Printing on Surfaces and Derivative Articles,” by Whitesides, et al., published as WO 96/29629 on Jun. 26, 1996; U.S. patent application Ser. No. 09/004,583, filed Jan. 8, 1998, entitled “Method of Forming Articles Including Waveguides via Capillary Micromolding and Microtransfer Molding,” by Kim, et al., now U.S. Pat. No. 6,355,198, issued Mar. 12, 2002; International Patent Application No. PCT/US01/16973, filed May 25, 2001, entitled “Microfluidic Systems including Three-Dimensionally Arrayed Channel Networks,” by Anderson, et al., published as WO 01/89787 on Nov. 29, 2001; U.S. Provisional Patent Application Ser. No. 60/392,195, filed Jun. 28, 2002, entitled “Multiphase Microfluidic System and Method,” by Stone, et al.; U.S. Provisional Patent Application Ser. No. 60/424,042, filed Nov. 5, 2002, entitled “Method and Apparatus for Fluid Dispersion,” by Link, et al.; U.S. Provisional Patent Application Ser. No. 60/461,954, filed Apr. 10, 2003, entitled “Formation and Control of Fluidic Species,” by Link, et al.; International Patent Application No. PCT/US03/20542, filed Jun. 30, 2003, entitled “Method and Apparatus for Fluid Dispersion,” by Stone, et al., published as WO 2004/002627 on Jan. 8, 2004; U.S. Provisional Patent Application Ser. No. 60/498,091, filed Aug. 27, 2003, entitled “Electronic Control of Fluidic Species,” by Link, et al.; International Patent Application No. PCT/US2004/010903, filed Apr. 9, 2004, entitled “Formation and Control of Fluidic Species,” by Link, et al., published as WO 2004/091763 on Oct. 28, 2004; International Patent Application No. PCT/US2004/027912, filed Aug. 27, 2004, entitled “Electronic Control of Fluidic Species,” by Link, et al., published as WO 2005/021151 on Mar. 10, 2005; U.S. patent application Ser. No. 11/024,228, filed Dec. 28, 2004, entitled “Method and Apparatus for Fluid Dispersion,” by Stone, et al., published as U.S. Patent Application Publication No. 2005-0172476 on Aug. 11, 2005; U.S. Provisional Patent Application Ser. No. 60/659,045, filed Mar. 4, 2005, entitled “Method and Apparatus for Forming Multiple Emulsions,” by Weitz, et al.; U.S. Provisional Patent Application Ser. No. 60/659,046, filed Mar. 4, 2005, entitled “Systems and Methods of Forming Particles,” by Garstecki, et al.; and U.S. patent application Ser. No. 11/246,911, filed Oct. 7, 2005, entitled “Formation and Control of Fluidic Species,” by Link, et al.

The following examples are intended to illustrate certain embodiments of the present invention, but do not exemplify the full scope of the invention.

### Example 1

This example illustrates the control the droplet formation using surface acoustic waves in a microfluidic device. Surface acoustic waves were created using an acoustic wave generator comprising an interdigitated transducer (IDT) on a piezoelectric material. The size (volume) of droplets, rate of droplet formation and polydispersity of droplets could all be independently controlled. The size of the droplets may also be changed without changing the geometry of the channel or the volume flow rates. Particularly, two types of drop-makers are shown in this example, using a flow focusing and a T-junction geometry. The control was very fast with a very low relaxation or response time. The size of each droplet that was formed in the droplet maker could also be separately controlled on a one by one basis. Thus, an emulsion of a mixture of droplets of a controlled number and volume could be formed, e.g., having any suitable distribution of volumes. The control is much faster than any other technique available and allows for direct control in a running formation process.

FIGS. 2A and 2B show two examples of drop-makers, in a flow focusing geometry and a T-junction. Acoustic wave generators may be placed at different positions with respect to the channels, as is shown in these figures. For completeness, a variety of acoustic wave generators at all different positions are shown in these figures, although this is by way of example only, and more or fewer acoustic wave generators may be present, and/or they may be positioned in different locations, in other embodiments of the invention.

FIG. 2A shows a droplet maker in a flow-focusing geometry and FIG. 2B shows a T-junction geometry. Placing the acoustic wave generators at different positions with respect to the channels acts on the fluid conditions, e.g., the pressure, flow rates, and/or other parameters that affect droplet formation.

### Example 2

To illustrate the working principle and a typical SAW (surface acoustic wave) induced droplet breakup, a droplet formation experiment using the flow focusing geometry where only one acoustic wave generator (an interdigited transducer in this example) was used (indicated by “A”) to control the droplet breakup by adjusting the electrical power is shown in this example

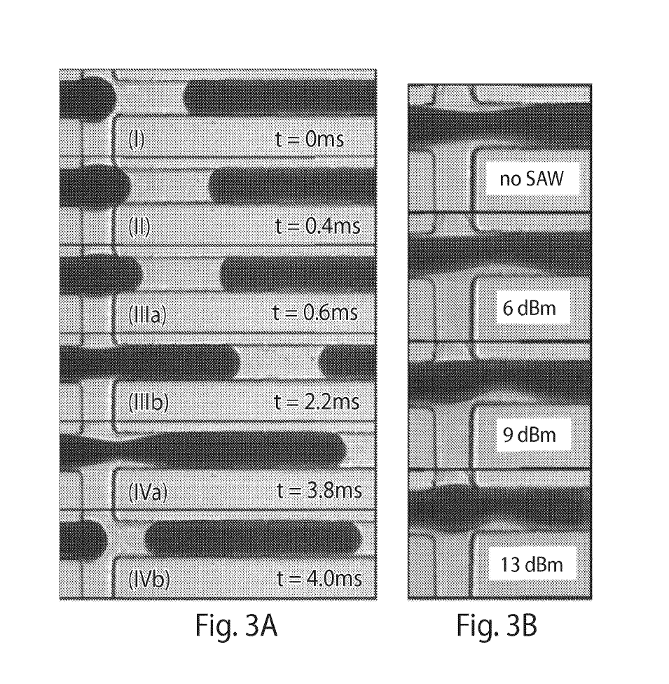

FIG. 3A shows droplet formation without application of SAWs. Droplets (black) form at the junction by a narrowing of the neck of fluid until a droplet pinches off. The intermediate states were all cylindrically symmetric. FIG. 3B shows additional actuation of a SAW of the powers listed (in dBm) as indicated in each image. This is observed as a slight asymmetry. Depending on the SAW power, the breakup process may be controlled and the droplet size or volume regulated.

FIG. 4A shows droplets volumes controlled by applying a continuous SAW at powers of 5 dBm, 7 dBm, 9 dBm, 11 dBm, 13 dBm, and 15 dBm, respectively. FIG. 4B shows control of the droplet size of adjacent droplets using SAWs at different pulse length ratios (one pulse to the next pulse), e.g., 8:10, 8:16, and 8:22. These are by way of example only; and any suitable pulse length ratios may also be used.

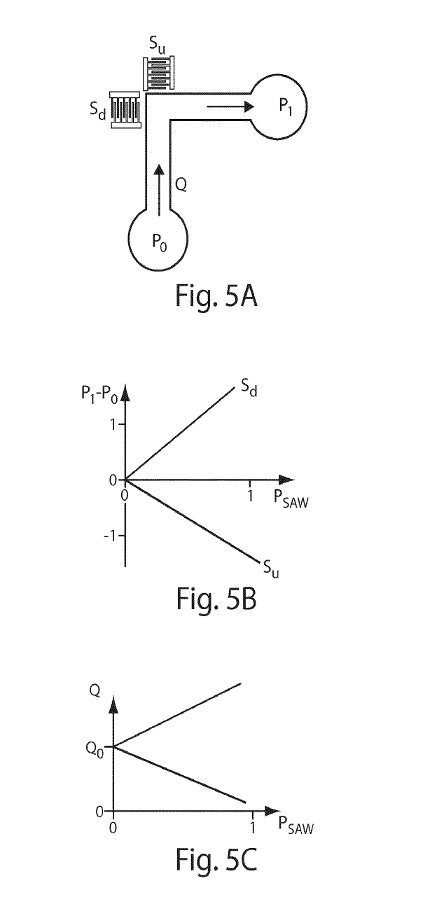

In FIG. 5, the placement of the acoustic wave generators at the corner of a bend may be used to control whether the SAW increases (Sᵤ) or decreases (S_{d}) the pressure difference from an initial position P₀ to a final position P₁, and the flow of fluid from P₀ to P₁ at a flow rate Q. Similarly, the Sᵤ acoustic wave generator may be used to decrease the flow rate Q, while the S_{d} transducer may be used to increase the flow rate Q.

FIGS. 6A-6C show non-limiting examples of droplet makers and sorting junctions having various acoustic wave generators. The positioning of these acoustic wave generators is by way of example only, and there may be more or fewer than these and/or they may be positioned in different locations.

### Example 3

Partitioning and quantification of fluids in droplets are fundamental concepts for high-throughput applications in microfluidic systems. Picoliter droplets can serve as liquid containers for chemical and biological compounds and can be produced and manipulated at very fast rates. Drolets can be loaded with cells or bacteria and biochemical solutes can be added. Such droplets can be processed in microfluidic systems in many ways: they can be merged, split, partitioned, selected, directed or sorted; and even higher order emulsion droplets that contain droplets in droplets can be formed. The control and handling of minute amounts of discrete fluid volumes in microfluidics is very useful for cell sorting, drug discovery, protein crystallization, high-throughput screening, and directed evolution of cells and enzymes.

Droplet fluidics allows production and manipulation of droplets that make the basic operations for those applications extremely fast and efficient. Multiple operations can be integrated on a single chip and arranged in series similar to an assembly line. However, full exploitation of droplet fluidics is limited by the precise and real time control of droplet size and volume.

Droplets can be formed in an emulsification process by mechanical actuation, but the volume of those droplets is very polydisperse. Microfluidic techniques allow droplet formation with highly monodisperse droplet size distribution in custom-made glass capillaries and microfluidic channels. In PDMS channels, the T-junction and flow-focusing geometries have been used. The size of the droplets can depend on the designed geometry of the microchannels and the flow rates. In real time, droplet size can be regulated by flow rate changes, and the response times can be very long. Also, changes in flow rates affect the fluidics of the whole device, and the performance of other integrated components may be compromised. Using passive techniques, droplets can be split at obstacles or in a T-junction, forming daughter droplets of different volume ratios. Although passive breakup has high potential for parallelization, droplet size may be controlled by channel dimensions which limit its applicability. Active valves have been introduced to guide the flow in real time using multilayer and single layer PDMS devices. Such valves exploit the compliance of the device to pressurize and deform the elastic channels walls mechanically and have been applied to control droplet formation and droplet size. However, pressurizing involves external macroscopic pumps and valves and suffers from system compliance dependent response times.

These examples demonstrate droplet formation in a flow-focusing geometry that allows active and real time control of droplet size using surface acoustic waves. Acoustic actuation localizes at the flow-focus junction of a single droplet maker. The acousto-fluidic hybrid device is electronically activated. It is simple to fabricate and allows the control of droplet size at fast response times over a wide range.

The microfluidic devices were produced by standard soft-lithography using PDMS (polydimethylsiloxane). The cast PDMS mold was attached to a piezoelectric substrate made of LiNbO₃ (128° rot-Y-cut) in ozone-plasma. On the piezo-substrate, a tapered interdigitated transducer (IDT) made of two gold electrodes was deposited by vapor deposition. The electrode finger periodicity ranged from 23.0 micrometers <d<24.4 micrometers, corresponding to a working frequency of actuation of f=161-171 MHz. The IDT was carefully aligned in proximity to the flow junction. Precise adjustment was accomplished by fine tuning the frequency in the actuation range of the fully assembled device. To apply the high-frequency voltage, a GHz-signal generator (Rhode Schwarz SMP02) was used to amplify the signal to a power of P_{SAW}=200-800 mW. The assembled hybrid device was mounted on a microscope stage and observed with a video enhanced light microscope and a fast camera (Photron Fastcam). To demonstrate control of droplet size, water droplets were produced in HFE-7500 fluorocarbon oil, stabilized by 1.8 wt % of the fluorosurfactant ammonium carboxylate of DuPont Krytox 157. To enhance the optical contrast of the droplets, bromphenol blue was added to the aqueous solution.

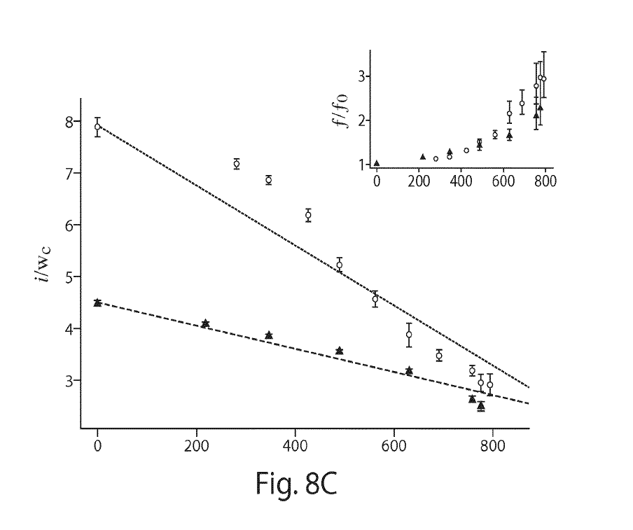

The droplets were produced in a flow-focusing PDMS device of 30 micrometer width and 30 micrometer height, as shown in FIG. 8. For the dispersed aqueous phase, a flow rate of Q_{d}=100 microliters/h was used, and for the continuous oil phase, Q_{c}=50 microliters/h and Q_{c}=100 microliters/h were used. These droplets had a length of 230 micrometers and 130 micrometers, and were produced at a rate of 210 s⁻¹ and 370 s⁻¹, respectively. As can be seen from the micrographs in FIG. 8, the application of the SAW decreased the length of the droplets generated in the cross-junction of the flow-focusing device. The rate of droplet formation increased accordingly. The droplet size decreased with increasing SAW power to 37% of the original size without SAW at a power of 800 mW at a flow rate of Q_{d}=100 microliters/h and Q_{c}=50 microliters/h. For a higher flow rate of the continuous phase of Q_{c}=100 microliters/h, the droplet size decreased to 57% for the same value of power.

FIG. 8A shows droplet formation in the cross junction geometry (flow-focusing). The thin arrows denote the flow directions, the thick arrow denotes the direction of the SAW. FIG. 8B shows the effect of SAW on droplet formation and size. Droplet size decreased with the electric power of the SAW from 236 micrometers to 88 micrometers for Q_{c}=50 microliters/h. The scale bars indicate 100 micrometers. FIG. 8C shows a plot of droplet length normalized by channel width w_{c} against SAW power for Q_{c}=50 microliters/h (circles) and Q_{c}=100 microliters/h (triangles). The error bars denote standard deviation. The dashed lines show a linear fit with the intercept fixed at the droplet length for P_{SAW}=0. The slopes were m=−160 micrometers/W and m=−62 micrometers/W. The inset shows the droplet rate normalized to a rate at P_{SAW}=0 against SAW power.

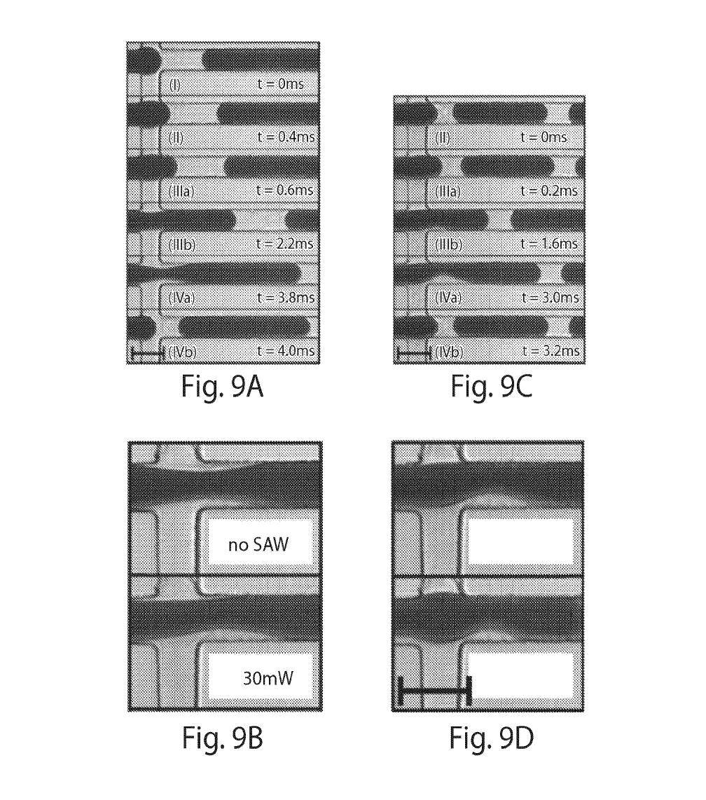

The effect of the SAW on the break-up process can be seen in a direct comparison of undisturbed (without SAW) and SAW-actuated droplet formation as shown in FIG. 9. FIG. 9A shows the droplet breakup without SAW is symmetic (IIIa), (IVa). FIG. 9C shows that with SAW (490 mW) the pinch-off was asymmetric as shown in stages (IIIb) and (IVa), and the pinch-off was shifted downstream. In this case, stage (I) cannot be observed because the dispersed fluid always bridges the gap from the inlet to the outlet. In contrast, without SAW the dispersed phase detaches completely from the outlet walls (see stages (I) and (IVb)). FIGS. 9B and 9D show photomicrographs immediately before pinch-off of the drop. The SAW-induced pressure difference lead to an asymmetry of the neck. At low SAW power, the pinch-off took place in the cross-junction in between the upper and lower inlet channels. At higher SAW power, the pinch-off was shifted into the outlet channel. The flow rates were Q_{d}=100 microliters/h and Q_{c}=50 microliters/h. The scale bars denote 50 micrometers.

The break-up process in the undisturbed cross-junction was as follows: (I) The tip of the discontinuous phase enters the cross junction, bulging outwards; (II) the tip spans the whole cross junction and touches the outlet edges; (III) the emerging droplet elongates into the outlet channel while its radius at the junction decreases from an outward bulge to a neck; and (IV) the neck breaks, where the new droplet downstream and the tip of the discontinuous phase recoil back towards the inlet.

The SAW shifts the narrowing neck and the pinch-off-region further downstream, therefore stage (I) cannot be observed. The neck that eventually defines the position of drop-breakup was symmetric when no SAW is applied. The SAW created an asymmetry in the neck before the pinch-off that becomes more pronounced at higher SAW power as shown in FIGS. 9B and 9D.

Without wishing to be bound by any theory, it is believed that the break-up process in these experiments was a squeezing mechanism driven by interfacial effects. The dominance of the surface tension appears to be justified by the small value of the Capillary number in these experiments, i.e., Ca<0.006.

The droplet length was determined during phase (III) of the break-up process. The initial droplet length after pinch-off of the preceding droplet was given by the channel width w, and it increased with a velocity proportional to the flow rate of the discontinuous phase u_{d}=Q_{d}/wh. The final length then depended simply on time until pinch-off tau (τ). The droplet break-up was driven by a pressure increase in the inlets of the continuous fluid that squeezed the discontinuous fluid until eventually a droplet pinched off. This pressure increase was believed to be caused by the emerging droplet that blocked almost the entire outlet so that the continuous fluid flow was confined to the thin layer and narrow edges between the droplet and the microchannel walls. Once a critical pressure p_{crit} was reached, the neck collapsed and a new droplet was formed.

The pressure p across the emerging droplet may be estimated to be proportional both to the flow rate of the continuous phase and the hydrodynamic resistance of the confined path of the blocked outlet. With a hydrodynamic resistance proportional to the emerging droplet's length, p˜Q_{c}l, yielding a pinch-off length l˜p_{crit}/Q_{c}.

Without wishing to be bound by any theory, the effect of the SAW to increase the pressure in the lower inlet channel may be accounted for as follows. In a simple linear model, the effective pressure in the pinch-off region may be assumed to increase by p_{SAW}=aP_{SAW}. Therefore, the critical pressure was reached for smaller droplet lengths, i.e., 1˜(p_{crit}−aP_{SAW})/Q_{c}. In this model, the slope of the function dl/dP_{SAW}˜−a/Q_{c} would be expected to scale inversely with the continuous flow rate Q_{c}. For comparison, the experimental data may be fit with a linear regression analysis as shown in FIG. 8.

For the flow rate Q_{c}=50 microliters/h, the slope was found to be w_{c}⁻¹(dl/dP_{SAW}) 50 microliters/h=−5.3 micrometers/W, and for Q_{c}=100 microliters/h, the slope was found to be w_{c}⁻¹(dl/dP_{SAW}) 100 microliters/h=−2.1 micrometers/W, which was in reasonable agreement with the model (length normalized to channel width w_{c}). However, particularly for low SAW power, the measured droplet lengths were significantly higher than predicted. This simple linear model overestimated the effect of the SAW on droplet breakup below values of P_{SAW}<490 mW (for Q_{c}=50 microliters/h) and P_{SAW}<630 mW (for Q_{c}=100 microliters/h). For power values below this crossover the droplet lengths were typically above the fit and for values above the crossover, the lengths were below, as shown in FIG. 8C. A closer look at the pinch-off process in the micrographs of FIGS. 9B and 9D revealed the reason for this overestimation: the linear model disregards the effect of the second inlet channel. At low SAW powers, the pinch-off took place at the cross-junction, and the pressure increase by the SAW in the lower channel can partially relax into the upper channel. This reduced the effective SAW pressure. At higher SAW powers, the pinch-off was shifted further downstream into the outlet channel. In this situation, the upper channel was completely blocked and the effective pressure at the pinch-off region was only provided by the lower inlet.

Thus, these experiments demonstrate precise control on the droplet size in PDMS channels by acoustics and should be very useful to droplet fluidic applications.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
a microfluidic substrate having defined therein a droplet-producing junction of at least a first microfluidic channel and a second microfluidic channel configured and arranged to create droplets of a first fluid contained by a second fluid; and
an acoustic wave generator positioned to alter flow of fluid entering or leaving the droplet-producing junction.

2. The article of claim 1, wherein the first microfluidic channel is positioned within the second microfluidic channel.

3. The article of claim 1, wherein the first microfluidic channel and the second microfluidic channel form a T junction.

4-7. (canceled)

8. The article of claim 1, wherein the acoustic wave is generated by an acoustic wave generator, wherein the acoustic wave generator comprises one or more interdigitated transducers.

9-10. (canceled)

11. The article of claim 8, wherein at least one of the one or more interdigitated transducers is a tapered interdigitated transducer.

12. (canceled)

13. The article of claim 1, further comprising a second acoustic wave generator positioned to alter flow of fluid entering or leaving the droplet-producing junction.

14-15. (canceled)

16. The article of claim 1, wherein the substrate is a piezoelectric substrate.

17-18. (canceled)

19. A method, comprising:
flowing a first fluid through a first microfluidic channel and a second fluid through a second microfluidic channel such that, upon intersection of the first fluid and the second fluid at a junction, droplets of first fluid are formed contained by the second fluid; and
applying an acoustic wave to the first fluid and/or the second fluid able to alter the rate of creation of the droplets and/or the volume of the droplets, relative to in the absence of the acoustic wave.

20. The method of claim 19, wherein the acoustic wave is applied to at least a portion of the junction.

21. The method of claim 19, wherein the acoustic wave is applied to the first fluid and/or the second fluid upstream of the junction.

22. The method of claim 19, wherein the acoustic wave is applied to the first fluid and/or the second fluid downstream of the junction.

23. The method of claim 19, wherein the acoustic wave is able to alter the rate of creation of the droplets.

24. (canceled)

25. The method of claim 19, wherein the acoustic wave is able to alter the volume of the droplets.

26. (canceled)

27. The method of claim 19, comprising applying more than one acoustic wave to the first fluid and/or the second fluid.

28. The method of claim 19, wherein the acoustic wave creates a pressure within the first fluid and/or the second fluid that alters the rate of creation of the droplets and/or the volume of the droplets.

29. (canceled)

30. The method of claim 19, wherein the acoustic wave deflects the flow of the first fluid and/or the second fluid.

31-35. (canceled)

36. The method of claim 19, wherein the acoustic wave has a power of at least about 3 dBm.

37-40. (canceled)

41. The method of claim 19, wherein the droplets are created at a rate of at least 10 droplets/s.

42-53. (canceled)

54. An apparatus, comprising:
a microfluidic channel having a bend; and
an acoustic wave generator positioned to direct acoustic waves at at least a portion of the bend.

55-58. (canceled)

59. The apparatus of claim 54, wherein the microfluidic channel has a width that is no more than about the full width at half maximum (FWHM) of the acoustic wave front.

60. (canceled)
